(19) United States
(12) Patent Application Publication
(10) Pub. No.: US 2026/0077829 A1
(43) Pub. Date: Mar. 19, 2026

(54) TILTING AND SUPPORT KIT

(71) Applicant: GIVI S.P.A., Flero (BS) (IT)

(72) Inventor: Giuseppe VISENZI, Brescia (BS) (IT)

(73) Assignee: GIVI S.P.A., Flero (BS) (IT)

(21) Appl. No.: 19/109,868

(22) PCT Filed: Sep. 12, 2023
(86) PCT No.: PCT/IB2023/059028

§ 371 Date: Mar. 7, 2025

(30) Foreign Application Priority Data
Sep. 13, 2022 (IT) 102022000018654

(51) Int. Cl. B62J 9/24; B62J 9/27

(52) U.S. Cl. CPC B62J 9/24; B62J 9/27

(57) ABSTRACT

A tilting and support kit for at least one luggage of a motorcycle including a support frame adapted to be associated with a frame of the motorcycle. The support frame includes at least two tubular elements, a first tubular element and a second tubular element, a support mounted with the support frame and adapted to be separably engaged with the at least one luggage, at least one tilting device including a support base mounted with the at least one luggage and at least a hook-shaped element including at least one spacer arm including a first end hinged with the support base and a second end which includes a hook portion adapted to hook the first tubular element. The at least a hook-shaped element is adapted to rotate hinged from an unhooking position to a hooking position.

The present invention relates to a tilting and support kit.

WO 2020/245732 A1, to the Applicant, is known in the state of the art as disclosing a tilting and support kit for at least one luggage of a motorcycle, said tilting and support kit comprising a support frame adapted to be associated with a frame of said motorcycle, wherein said support frame comprises at least two portions, a first portion and a second portion, wherein said first portion is spaced from said second portion, wherein said first portion is arranged along a first geometrical axis and said second portion is arranged along a second geometrical axis, wherein said first geometrical axis is parallel to said second geometrical axis. The kit comprises support means that are adapted to separately engage said support frame and said at least one luggage, wherein said support means comprise at least a first support means adapted to engage said first portion of said support frame and a first portion of said at least one luggage corresponding to said first portion of said support frame and at least a second support means adapted to engage said second portion of said support frame and a second portion of said at least one luggage corresponding to said second portion of said support frame. Said kit comprises at least a tilting device comprising a support base and at least one hook-shaped element, wherein said at least one hook-shaped element comprises at least one spacer arm comprising a first end hinged with said support base and a second end, which comprises a hook portion adapted to hook said first portion of said support frame with said first portion of said at least one luggage, said at least one hook-shaped element being adapted to rotate hinged from an unhooking position to a hooking position. Said unhooking position of said at least one hook-shaped element provides that said hook portion unhooks said first portion of said support frame from said first portion of said at least one luggage. Said hooking position of said at least one hook-shaped element provides that said hook portion hooks said first portion of said support frame to said first portion of said at least one luggage. Said tilting and support kit is adapted to pass from a travel configuration to a tilted configuration. Said travel configuration of said tilting and support kit provides that said at least a first support means and said at least a second support means engage said at least one luggage with said support frame, and that said hook-shaped element of said tilting device is in said unhooking position. Said tilted configuration of said tilting and support kit provides that said at least a first support means disengages said first portion of said at least one luggage from said first portion of said support frame, that said at least a second support means engages said second portion of said at least one luggage with said second portion of said support frame, that said at least one luggage is tilted of an angle relative to a third geometrical axis and that said hook-shaped element is in said hooking position, wherein said third geometrical axis is coplanar to a geometrical plane passing through said first geometrical axis and through said second geometrical axis, wherein said third geometrical axis is perpendicular to said first and said second geometrical axis.

Disadvantageously, the release sliding block of the tilting device is not easily accessible and it is not possible to block the tilting device in the hooking position.

The object of the present invention is to make available a tilting and support kit for side luggages so that the lids of the side luggages can be fully opened even when a luggage is mounted with a top support frame, that the kit ensures a safe support of the luggage even when the luggage is tilted, that the kit allows the luggage to remain engaged with the support frame even when it is tilted, that both the hooking position and unhooking position can be locked, and that the two hooking and unhooking positions can be easily changed from an easily accessible and visible position.

According to the invention, such object is achieved with a tilting and support kit according to claim 1.

Other features are provided in the dependent claims.

The features and advantages of the present invention will be more apparent from the following description, which is to be understood as exemplifying and not limiting, with reference to the appended schematic drawings, in which:

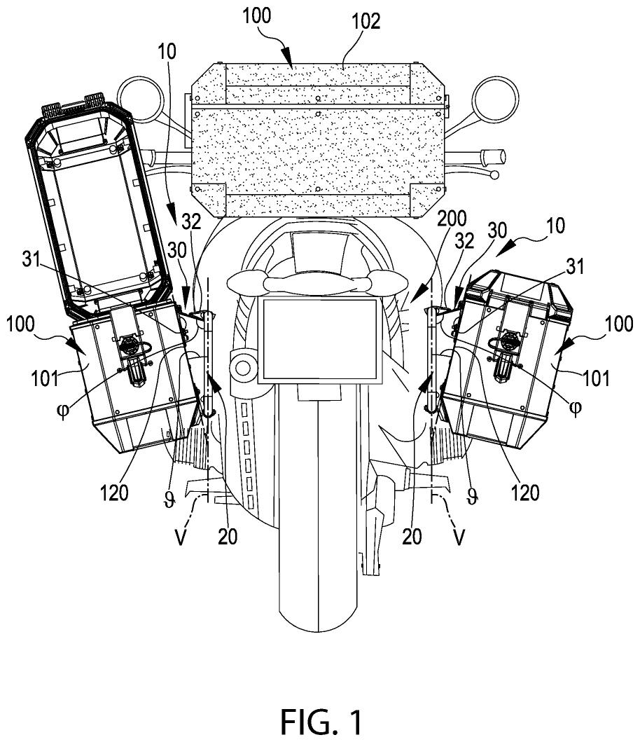

FIG. 1 shows a plan view from the rear of a motorcycle which mounts two tilting and support kits for luggages arranged at the sides of the motorcycle according to the present invention in a tilted configuration, each kit comprises a side support frame, each of which mounts a luggage, the motorcycle also mounts an upper support frame which mounts another luggage;

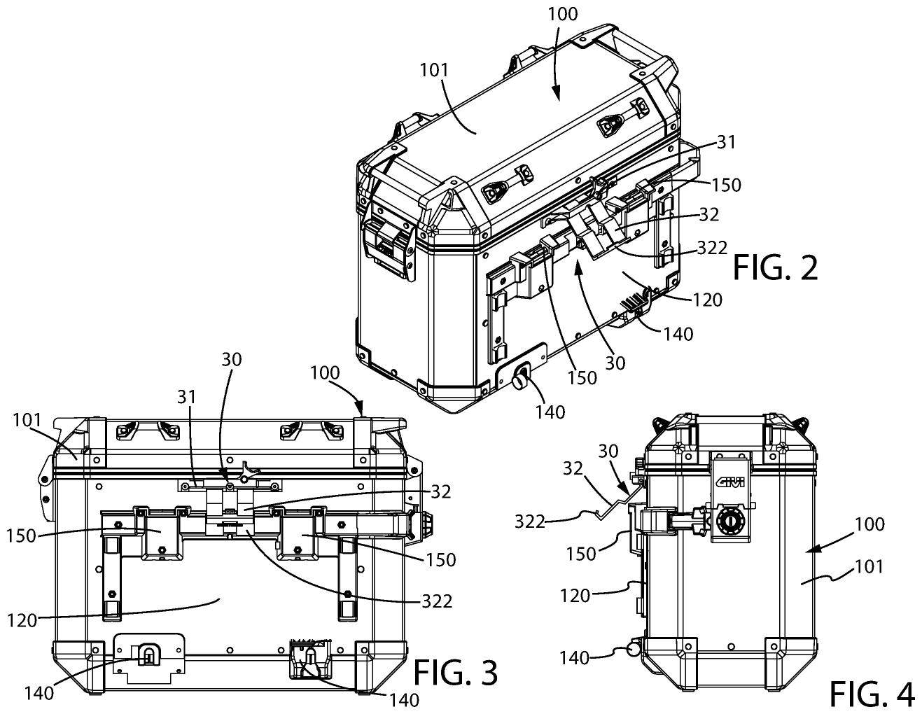

FIG. 2 shows a perspective view of the luggage disassembled from the support frame, wherein the luggage mounts a tilting device comprising a hook-shaped element rotated on a pin upwards in an tilted configuration, i.e. in a position adapted to hook the hook-shaped element with a first upper tubular element of the support frame;

FIG. 3 is a side plan view of FIG. 2;

FIG. 4 is a side plan view of FIG. 2;

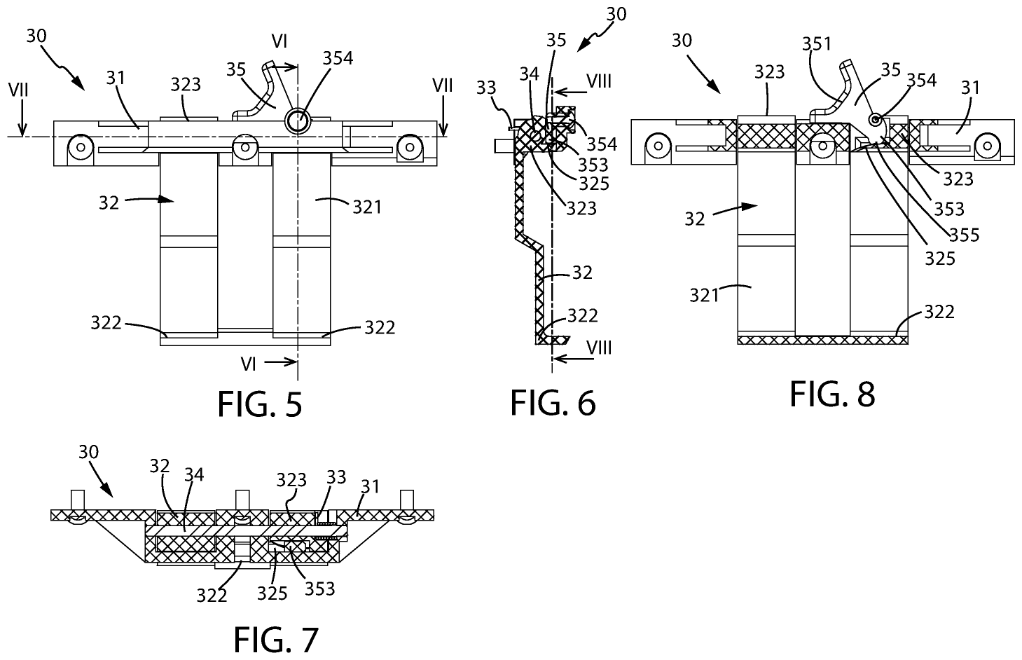

FIG. 5 is a plan view of the tilting and support device with the hook-shaped element in the unhooked position and a cam in the locked position with a base of the tilting and support device;

FIG. 6 is a section view according to the line VI-VI of FIG. 5;

FIG. 7 is a section view according to the line VII-VII of FIG. 5;

FIG. 8 is a section view according to the line VIII-VIII of FIG. 6;

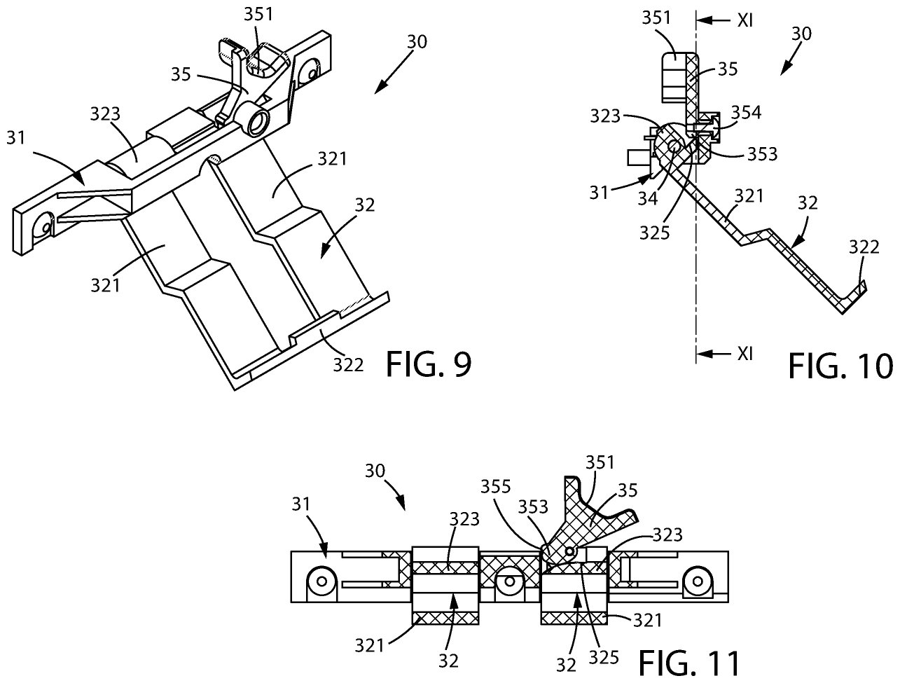

FIG. 9 shows a perspective view of the tilting and support device with the hook-shaped element in the hooking position and with the cam in the disengaging position from the support base;

FIG. 10 is a section view of FIG. 9 along a line similar to VI-VI of FIG. 5;

FIG. 11 is a section view according to the line XI-XI of FIG. 10;

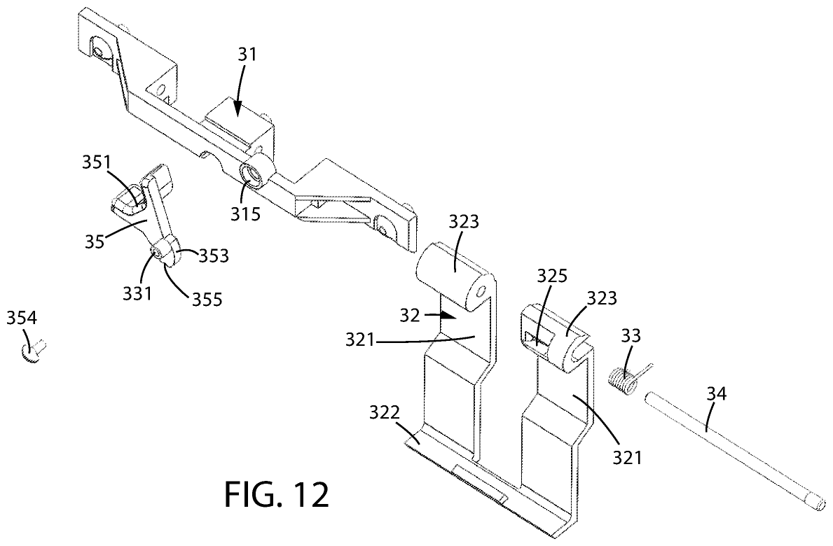

FIG. 12 shows an exploded view of the tilting and support device showing a pin, torsion spring, support base, hook-shaped element and cam;

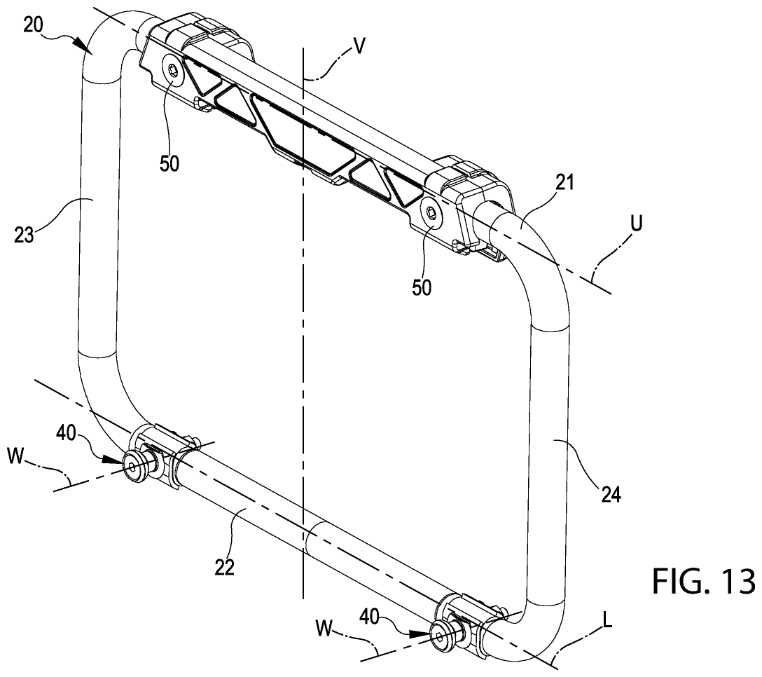

FIG. 13 shows a perspective view of the support frame that mounts the first upper support means and two second lower support means, wherein each second lower support means comprises a stem which comprises a head of greater transverse dimensions relative to the transverse dimensions of the stem;

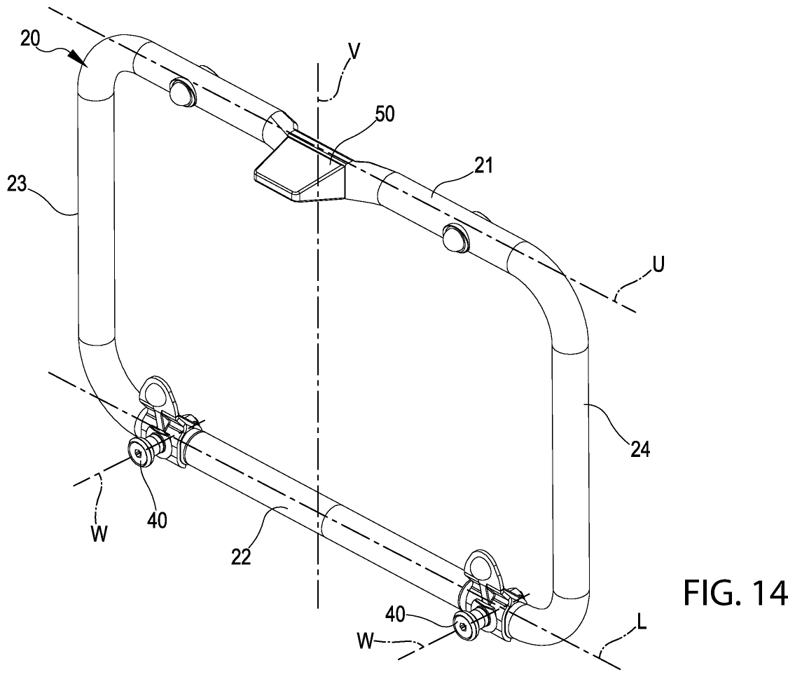

FIG. 14 shows a perspective view of a support frame alternative to the one shown in FIG. 13 which mounts a single first upper support means.

With reference to the aforementioned figures and in particular FIG. 1, a motorcycle is shown that mounts two tilting and support kits 10 for luggages 100, 101 arranged at the sides of the motorcycle. Each of the two kits 10 is in the tilted configuration. Each kit 10 comprises a side support frame 20, each of which mounts a side luggage 101. The motorcycle also mounts an upper support frame 20 which mounts another upper luggage 100, 102.

The tilting and support kit 10 for at least one luggage 100, 101 of a motorcycle is mounted at the sides in the figures.

The support frame 20 is adapted to be associated to a frame 200 of said motorcycle.

As shown in FIGS. 1, 13-14 said support frame 20 comprises at least two tubular elements 21-24, a first tubular element 21 and a second tubular element 22.

Said first tubular element 21 is an upper portion of said support frame 20 and said second tubular element 22 is a lower portion of said support frame 20.

The support frame 20 shown in the figures comprises four tubular elements 21-24.

Said first tubular element 21 is spaced from said second tubular element 22. Said first tubular element 21 is arranged along a first upper geometrical axis U and said second tubular element 22 is arranged along a second lower geometrical axis L, wherein said first geometrical axis U is parallel to said geometrical axis L.

The tilting and support kit 10 comprises support means 40, 50 mounted with said support frame 20 and adapted to be separably engaged with said at least one luggage 100, 101.

As shown in FIG. 13 said support means 40, 50 comprise two first upper support means 50 mounted with said first upper tubular element 21 and two second lower support means 40 mounted with said second lower tubular element 22.

The kit 10 comprises engaging means 150, 140 mounted with said at least one luggage 100, 101.

Said engaging means 140, 150 shown in the FIGS. 2-4 comprise two first upper engaging means 150 adapted to be engaged with two first upper support means 50 and two second lower engaging means 140, each second lower engaging means 140 is adapted to be engaged with said at least a second support means 40.

As shown in particular in FIGS. 2-4, said first engaging means 150 is mounted with an upper portion of said at least one luggage 100, 101 and said second engaging means 140 is mounted with a lower portion of said at least one luggage 100, 101.

As shown in particular in FIGS. 13 and 14 said at least one second support means 40 mounted with said second lower tubular element 22 comprises a stem which extends along a longitudinal axis W from said second tubular element 22. Said stem comprises a head. Said head has transverse dimensions greater than transverse dimensions of said stem. The transverse dimensions are measured on a transverse geometrical plane which is perpendicular to said longitudinal axis W along which the stem extends.

As shown in the figures said head has a mushroom shape adapted to be quickly connected to a complementary opening of the second lower engaging means 140.

Said second support means 40 is adapted to pass from an engaging configuration with said second engaging means 140 to a disengaging position from said second engaging means 140.

Advantageously the second support means 40 allows the luggage 100, 101 to tilt maintaining the second support means 40 engaged with said second engaging means 140.

As shown in particular in FIGS. 2-12, the kit 10 comprises a tilting device 30 comprising a support base 31 mounted with said at least one luggage 100, 101 and at least one hook-shaped element 32.

Said hook-shaped element 32 comprises two spacer arms 321. Each spacer arm 321 comprises a first end 323 hinged with said support base 31. A second end of the two spacer arms 321 comprises a hook portion 322 adapted to hook said first tubular element 21.

Said hook-shaped element 32 is adapted to rotate hinged from an unhooking position to a hooking position.

Said unhooking position of said hook-shaped element 32 provides that said hook portion 322 is unhooked from said first tubular element 21 as shown in FIGS. 5-8.

Said hooking position of said at least one hook-shaped element 32 provides that said hook portion 322 is hooked to said first tubular element 21 as shown in FIGS. 1, 2-4, 9-11.

Said tilting and support kit 10 being adapted to pass from a travel configuration to a tilted configuration.

As shown in the Figures said travel configuration of said tilting and support kit 10 provides that said at least a first support means 50 and said at least a second support means 40 are engaged with said at least one luggage 100, 101 and that said hook-shaped element 32 of said tilting device 30 is in said unhooking position,

As shown in the Figures said tilted configuration of said tilting and support kit 10 provides that said first support means 50 is unhooked from said luggage 100, 101, that said second support means 40 is engaged with said luggage 100, 101, that said luggage 100, 101 is tilted of an angle θ relative to a third geometrical axis V and that said hook-shaped element 32 is in said hooking position.

Said third geometrical axis V is coplanar to a geometrical plane passing through said first geometrical axis U and through said second geometrical axis L, wherein said third geometrical axis V is perpendicular to said first U and said second geometrical axis L.

As shown in FIG. 1 if the tilting and support kit 10 is mounted at the sides of the frame 200 of the motorcycle, then the third geometrical axis V is a vertical axis perpendicular to the ground.

The angle θ is between 0 and 60 sexagesimal degrees.

A constraint to the extension of the angle θ depends on the length of the spacer arms 321 of the hooked element 32 of the tilting device 30.

Another constraint to the extension of the angle θ depends on the length of the stem and on the transverse dimensions of the head of the second support means 40, as the dimensions of the stem and of the head constrain the maximum engaging angle between the second support means 40 and the second engaging means 140. Beyond said maximum engaging angle the luggage 100, 101 is disengaged, at least at the bottom, from the support frame 20.

As shown in particular in FIGS. 5-12 said first end 323 of said spacer arms 321 of said tilting device 30 is hinged with said support base 31 by means of a pin 34 which mounts a torsion spring 33.

Said pin 34 is arranged along a fourth geometrical axis H, wherein said fourth geometrical axis H is parallel to said first geometrical axis U and consequently is parallel to said second geometrical axis L.

Said torsion spring 33 passes from a position of higher torsion to a position of lower torsion to make said hook-shaped element 32 rotate around the pin 34.

Said position of higher torsion of said torsion spring 33 corresponds to said unhooking position of said at least one hook-shaped element 32.

Said position of lower torsion of said torsion spring 33 corresponds to said hooking position of said at least one hook-shaped element 32.

As shown in FIGS. 5-12 said at least one tilting device 30 comprises a lever 35 rotatably mounted with said support base 31 by means of a second pin 354 which identifies a rotation axis perpendicular to the first pin 34.

Said lever 35 comprises a handleable first end 351 and a second cam-shaped end 353.

The second cam-shaped end 353 eccentrically hinges said second pin 354 as shown in particular in FIGS. 8, 11 and 12.

Said first end 323 of said at least one spacer arm 321 of said at least one tilting device 30 comprises a contact portion 325 in contact with said second cam-shaped end 353 of said lever 35.

Advantageously, the contact portion 325 always remains in contact with the second cam-shaped end 353 in any position of the lever 35.

Said lever 35 passes from a first position wherein a distance between said second pin 354 and said contact portion 325 is maximum, as shown in particular in FIG. 8, to a second position wherein said distance between said second pin 354 and said contact portion 325 is minimum, as shown in particular in FIG. 11.

Said first position of the lever 35 corresponds to said unhooking position of said at least one hook-shaped element 32.

Said second position of the lever 35 corresponds to said hooking position of said at least one hook-shaped element 32.

Even more advantageously, said cam-shaped portion 353 of said lever 35 comprises an arc-shaped form, wherein said arc-shaped form comprises a first arc end which mounts said second pin 354 and a second arc end which is distant from said first arc end as shown in FIGS. 5-12.

Even more advantageously, said second arc end of said cam-shaped portion 353 of said lever 35 comprises a flat portion 355 that keeps blocked the first position of the lever 35 which provides that said flat portion 355 remains in contact with the contact portion 325 of said first end 323 of said at least one spacer arm 321 of said at least one tilting device 30.

Even more advantageously said contact portion 325 of said first end 323 of said at least one spacer arm 321 of said at least one tilting device 30 is curvilinear in shape.

The curvilinear shape of the contact portion 325 is complementary to the arc shape of the cam-shaped end 353 of the lever 35 to advantageously allow for greater distance between the second pin 354 and the surface of the contact portion 325.

It is pointed out that said greater torsion position of said torsion spring 33 corresponds to said unhooking position of said at least one hook-shaped element 32 and to said first position of said lever 35, while said lesser torsion position of said torsion spring 33 corresponds to said hooking position of said at least one hook-shaped element 32 and to said second position of said lever 35.

By rotating the lever 35 from the second to the first position said at least one hook-shaped element 32 is gradually returned to the unhooking position and the luggage can be unhooked normally.

As shown in particular in FIGS. 5-12 said hook portion 322 of said spacer arm 321 comprises a wall of a shape complementary to a shape of said first tubular element 21 of said support frame 20. When said hook portion 322 is hooked with said first tubular element 21, then the wall of a complementary shape adheres for at least a portion with an external surface of said first tubular element 21.

The first end 323 of the hook-shaped element 32 hinged with said support base 31 is provided to be arranged on an upper portion of the luggage 100, 101 so that once the lever 35 passes from the first position to the second position, the hook-shaped element 32 can rotate hinged and pushed by the torsion spring 33 from said unhooking position wherein the hooked element 32 is adhering to a rear face 120 of the luggage 100, 101 to the hooking position of said hook-shaped element 32 with said first tubular element 21. Said hook portion 322 of the hook-shaped element 32 engages the first tubular element 21 from below. The complementary wall of the hook portion 322 embraces the first tubular element 21 for at least a portion of the diameter of the first tubular element 21.

In the tilted configuration of the kit 10 a second angle φ between the third geometrical axis V and the spacer arm 321 as shown in FIGS. 5-12 is less than 90 sexagesimal degrees, as the tilting device 30 is blocked in the first and second position by the lever 35.

Said support base 31 of the tilting device 30 is mounted with the rear face 120 of the luggage 100, 101 facing the support frame 20. Said engaging means 140 and 150 are provided mounted with the rear face 120 of the luggage 100, 101.

Advantageously the tilting and support kit 10 for luggages 100 provides that a lid of the luggage 100 can be completely opened even in the presence of a luggage mounted so as to block the opening of the lid when the kit 10 is in the travel configuration.

Advantageously the kit 10 ensures a secure support for the luggage 100 even when the luggage 100 is tilted.

Advantageously the kit 10 allows the luggage 100 to remain engaged with the support frame 20 also in the tilted position.

Advantageously, the kit 10 allows both the engaging and disengaging positions to be blocked.

Advantageously, the kit 10 allows the two hooking and unhooking positions to be easily changed from an easily accessible and visible position.

Alternatively, it is possible to provide that the support frame 20 comprises only the first tubular element 21 and the second tubular element 22.

Alternatively, it is possible to provide that the luggage 100 can also mount two or more tilting devices 30.

Alternatively, it is possible to provide that the tilting and support kit 10 for at least a luggage 100, 101 of a motorcycle can be mounted above the motorcycle in place of the upper support frame 20 in order to be able to tilt the upper luggage 102 relative to a geometric plane defined by the support frame 20. In this alternative the first tubular element 21 is at the front, while the second tubular element 22 is at the rear and the upper luggage 100, 102 tilts of the angle θ upwards. Again alternatively depending on how we wish to tilt the luggage, the first tubular element 21 is at the rear and the second tubular element 22 is at the front.

Alternatively, it is possible to provide that the side luggage 101 can be tilted towards the front or the rear and in this case, the first tubular element 21 and the second tubular element 22 are side tubular elements of the support frame 20.

Alternatively, it is possible to provide that the luggage 100, 101, 102 is replaced by a similar bulk, for example a tank or a saddle bag or other accessory as bulky as a luggage.

Alternatively, it is possible to provide that the support means 40, 50 are engaged directly with the luggage 100 without engaging means 150, 140.

Alternatively, as shown in FIG. 14 there is only one support means 50 which is a lug and which provides an alternative first engaging means 150 which is an opening passing through said lug.

As shown in particular in FIG. 1 in the tilted configuration of the kit 10 the second angle o between the third geometrical axis V and the spacer arms 321 is preferably an angle greater than 90 sexagesimal degrees so that the spacer arms 90 hangs from the top downwards, wherein the first end 323 hinged with said support base 31 is arranged at a height greater than the second end of the hook portion 322 engaged with said first tubular element 21. The height is measured relative to the third geometrical axis V starting from the second geometrical axis L and going towards the first geometrical axis U.

Alternatively the second angle φ between the third geometrical axis V and the spacer arm 321 is between 10 and 170 sexagesimal degrees.

Alternatively, it is possible to provide that the support frame 20 is a metal sheet or plate adapted to be associated to the frame 200 of said motorcycle, wherein said alternative support frame 20 comprises at least two portions 21-24, a first portion 21 and a second portion 22, wherein said first portion 21 is spaced from said second portion 22. Said first portion 21 is an upper portion of the support frame 20 and said second portion 22 is a lower portion of the support frame 20. Said first portion 21 is arranged along the first geometrical axis U and said second portion 22 is arranged along the second geometrical axis L, wherein said first geometrical axis U is parallel to said second geometrical axis L.

Again alternatively it is provided that said support frame 20 is integral with said frame 200 of said motorcycle, so that the support means 40, 50 are mounted with said frame 200 of the motorcycle.

Alternatively the torsion spring 33 may be replaced by another equivalent elastic element, or the pin 34 and spring 33 system may be replaced by a counterweight without spring.

Alternatively said support means 40, 50 are mounted with said at least one luggage 100, 101, 102, where said at least a first support means 50 is mounted with said first portion of said at least one luggage 100, 101, 102 and said at least a second support means 40 is mounted with said second portion of said at least one luggage 100, 101, 102.

Alternatively said support base 31 of said at least one tilting device 30 is mounted with said support frame 20, wherein said hook portion 322 is adapted to hook said first portion of said at least one luggage 100, 101, 102.

The invention thus conceived is susceptible to many modifications and variants, all falling within the same inventive concept; furthermore, all details can be replaced by equivalent technical elements. In practice, the materials used, as well as their dimensions, can be of any type according to the technical requirements.

1. A tilting and support kit for at least one luggage of a motorcycle, said tilting and support kit comprising:
a support frame adapted to be associated with a frame of said motorcycle, wherein said support frame comprises at least two portions, a first portion and a second portion, wherein said first portion is spaced from said second portion, wherein said first portion is disposed along a first geometrical axis and said second portion is disposed along a second geometrical axis, wherein said first geometrical axis is parallel to said second geometrical axis;
support means which are adapted to separably engage said support frame and said at least one luggage, wherein said support means comprise at least a first support means adapted to engage said first portion of said support frame and a first portion of said at least one luggage corresponding to said first portion of said support frame and at least a second support means adapted to engage said second portion of said support frame and a second portion of said at least one luggage corresponding to said second portion of said support frame; and
at least one tilting device comprising a support base and at least one hook-shaped element, wherein said at least one hook-shaped element comprises at least one spacer arm comprising a first end hinged with said support base and a second end which comprises a hook portion adapted to hook said first portion of said support frame to said first portion of said at least one luggage, said at least one hook-shaped element being adapted to rotate hinged from an unhooking position to a hooking position,
said unhooking position of said at least one hook-shaped element provides that said hook portion unhooks said first portion of said support frame from said first portion of said at least one luggage,
said hooking position of said at least one hook-shaped element provides that said hook portion hooks said first portion of said support frame to said first portion of said at least one luggage,
said tilting and support kit being adapted to pass from a travel configuration to a tilted configuration,
said travel configuration of said tilting and support kit provides that said at least a first support means and said at least a second support means engage said at least one luggage with said support frame and that said hook-shaped element of said tilting device is in said unhooking position,
said tilted configuration of said tilting and support kit provides that said at least a first support means disengages said first portion of said at least one luggage from said first portion of said support frame, that said at least a second support means engages said second portion of said at least one luggage with said second portion of said support frame, that said at least one luggage is tilted of an angle relative to a third geometrical axis and that said hook-shaped element is in said hooking position, wherein said third geometrical axis is coplanar to a geometrical plane passing through said first geometrical axis and through said second geometrical axis, wherein said third geometrical axis is perpendicular to said first and said second geometrical axis,
wherein said first end of said at least one spacer arm of said at least one tilting device is hinged with said support base by means of a first pin,
wherein said pin is disposed along a fourth geometrical axis, wherein said fourth geometrical axis is parallel to said first geometrical axis,
wherein said at least one tilting device comprises a lever rotatably mounted with said support base by means of a second pin that identifies a rotation axis perpendicular to the first pin,
wherein said lever comprises a handleable first end and a cam-shaped second end,
wherein the cam-shaped second end eccentrically hinges said second pin,
wherein said first end of said at least one spacer arm of said at least one tilting device comprises a contact portion in contact with said cam-shaped second end of said lever,
wherein said lever passes from a first position wherein a distance between the second pin and said contact portion is maximum, to a second position wherein said distance between the second pin and said contact portion is minimum,
wherein said first position of the lever corresponds to said unhooking position of said at least one hook-shaped element, and
wherein said second position of the lever corresponds to said hooking position of said at least one hook-shaped element.

2. The tilting and support kit according to claim 1, wherein said cam-shaped portion of said lever comprises an arch-shaped form, wherein said arch-shaped form comprises a first arch end mounting said second pin and a second arch end away from the first arch end.

3. The tilting and support kit according to claim 2, wherein said second arch end of the cam-shaped portion of said lever comprises a flat portion that keeps blocked the first position of the lever providing that said flat portion remains in contact with the contact portion of said first end of said at least one spacer arm of said at least one tilting device.

4. The tilting and support kit according to claim 1, wherein said contact portion of said first end of said at least one spacer arm of said at least one tilting device is of curvilinear in shape.

5. The tilting and support kit according to claim 1,
wherein said first pin mounts a torsion spring,
wherein said torsion spring passes from a greater torsion position to a lesser torsion position,
wherein said greater torsion position of said torsion spring corresponds to said unhooking position of said at least one hook-shaped element and to said first position of said lever, and
wherein said lesser torsion position of said torsion spring corresponds to said hooking position of said at least one hook-shaped element and to said second position of said lever.

6. The tilting and support kit according to claim 1, wherein said hook portion of said spacer arm comprises a wall of a shape complementary to a shape of said first portion of said support frame.

7. The tilting and support kit according to claim 1, wherein said support base of said at least one tilting device is mounted with said at least one luggage, wherein said hook portion is adapted to hook said first portion of said support frame.

8. The tilting and support kit according to claim 1, further comprising engaging means mounted with said at least one luggage, said engaging means comprising at least a first engaging means adapted to be engaged with said at least a first support means and at least a second engaging means adapted to be engaged with said at least a second support means.

9. The tilting and support kit according to claim 8, wherein said first engaging means is mounted with said first portion which is an upper portion of said at least one luggage and said second engaging means is mounted with said second portion which is a lower portion of said at least one luggage, said first portion is an upper portion of said support frame and said second portion is a lower portion of said support frame.

10. The tilting and support kit according to claim 1, wherein said at least two portions of said support frame are at least two tubular elements, said first portion is a first tubular element and said second portion is a second tubular element, wherein said first tubular element is disposed along said first geometrical axis and said second tubular element is disposed along said second geometrical axis.
